(19) United States
(12) Patent Application Publication
(10) Pub. No.: US 2013/0234465 A1
(43) Pub. Date: Sep. 12, 2013

(54) ADJUSTABLE MOTORCYCLE WINDSHIELD

(71) Applicant: TB INDUSTRIES, INC., St. Michael, MN (US)

(72) Inventor: Timothy R. Boesch, Otsego, MN (US)

(21) Appl. No.: 13/856,745

(22) Filed: Apr. 4, 2013

Related U.S. Application Data
(63) Continuation of application No. 13/240,962, filed on Sep. 22, 2011, now abandoned.

(51) Int. Cl. B62J 17/04

(52) U.S. Cl. CPC B62J 17/04
USPC 296/78.1

(57) ABSTRACT

An adjustable-height windscreen for a motorcycle or other recreational vehicle. The windscreen may include a base portion that is attachable to a vehicle, and an upper portion that is moveable between a predetermined lower position and a predetermined raised position. The windscreen may also be positionable at any desired position in between a lower position and a raised position. The base portion may be tinted, while the upper portion may be transparent.

### RELATED APPLICATION

This application is a Continuation of application Ser. No. 13/240,962 filed Sep. 22, 2011, the disclosure of which is hereby incorporated by reference in its entirety.

### FIELD OF THE INVENTION

The present invention relates generally to motorcycle windscreens. More particularly, the present invention relates to a fairing-mounted windscreen of adjustable height.

### BACKGROUND OF THE INVENTION

For motorcycle riders, choosing the proper windshield height is of the utmost importance. Using a windshield of appropriate height is not only necessary for safety and protection reasons, but directly impacts riding comfort as well.

A windshield of taller height offers protection against wind, rain, cold, and road debris, but does not allow much air circulation for the rider, which is often desired for its cooling effect on hot days. A shorter windshield offers the rider increased air flow, which may be desirable on warm days, and a more stylish design, but does little to protect the rider against tough weather conditions like wind, rain, or cold.

Further, the rider's sightline relative to the windshield is also important when choosing a windshield height when a taller windshield is desired. Most riders like to have the top edge of the windshield sitting just below their line of vision when seated comfortably. This allows the rider to see over the windshield without straining, yet still be able to drop down and look through the windshield if conditions warrant. A related concern is the air flow over the windshield into the rider. Primarily, the concern is that the air will deflect off of the motorcycle's windshield and into the rider's head and catch the rider's head in turbulence. To counteract this, some riders prefer to have a slightly lower windshield so that the wind flowing off the windshield deflects off the rider's body rather than his head. Other riders prefer to have an even higher windshield such that the air flows off the windshield and over the rider's head. However, motorcycle riders vary in size and height. Thus, fitting windshields to all possible riders becomes impossible when the windshields come in a finite amount of heights.

Typically, motorcycle windshields have a fixed height. The height can vary among different windshields, but generally cannot be adjusted so that the height is variable on the same windshield. A motorcycle rider can therefore only have a tall windshield or a short windshield on his motorcycle at any one time. While this is generally not a problem for the rider who stays close to home (or close to a source of a differing height windshield), riders who travel far from home are at the mercy of changing weather or road conditions. For example, if a rider leaves his home on a very hot, calm day, he will likely do so with a short windshield that provides air flow to him. However, should it start to rain or gust when the rider is far from home, he will be in a precarious position with no windshield protection.

Carrying additional windshields such as in a saddle bag is impractical. A taller windshield would be bulky and difficult to fit in any motorcycle's side bag. Further, the risk of scratching the windshield would be high.

Further, while tinted windshields are desirable to some riders for style and/or function, their maximum allowable height is typically limited by regulation. Choosing a tinted windshield often means compromising with the various drawbacks associated with short windshields discussed herein.

Thus, there is a need for a motorcycle windshield that is adjustable to different heights. An easily adjustable windshield would provide the motorcycle rider the comfort and style of riding with a short windshield, yet afford him the flexibility of being able to easily and quickly switch to a taller-style windshield if conditions warrant, and vice versa. Further, a fully adjustable windshield solves the problem of handling the variation among rider heights.

### SUMMARY OF THE INVENTION

An adjustable motorcycle windshield according to embodiments of the present application substantially meets the aforementioned needs of the industry. The windshield according to embodiments of the invention is adjustable to multiple heights.

In one embodiment, the windshield can be set at a fixed short height and easily adjusted to a fixed tall height, or vice versa. A windshield that is adjustable by the rider in this manner solves the problem of choosing between comfort and safety. In effect, a windshield of this embodiment allows the rider to have both, without the burden of carrying additional windshields. For example, a rider leaving his house on a hot day can do so with the windshield in the fixed short position. This allows for air circulation to the rider and is often desirable for its more stylish design. However, should the rider happen upon inclement weather during his ride, he can simply pull off the road, loosen a few fasteners, flip the windshield over, re-secure the fasteners, and continue his ride with the windshield in the fixed tall position. Adjusting the windshield to the fixed tall position allows the rider to continue his ride safely, as the new windshield height protects the rider against wind, rain, cold, and road debris. Similarly, should the rider leave his house on a cold, rainy day, he can do so with the windshield in the fixed tall position, knowing that he can later flip the windshield over to the fixed short position once he reaches hot weather.

In another embodiment, the windshield can be set at a tall height, a short height, and any height in between. A windshield that is adjustable to any height not only solves the problem of picking between comfort and safety, as described in the aforementioned embodiment, but also addresses the issue of fitting the windshield to individual rider size and height. While one rider may appropriately utilize the windshield's tallest height, that height may be inappropriate for a rider of slightly different height. For example, when the windshield is set at its tallest position, a slightly taller rider may experience turbulence from the wind flow off the windshield, as his head would sit above the windshield in prime turbulence position. Likewise, a slightly shorter rider utilizing the windshield at its tallest height may not suffer from the turbulence problem, but could potentially have his view obstructed by the edge of the windshield. A windshield of fully adjustable height solves these problems. The taller rider can adjust the height to one that is taller and appropriate for him such that his head is not caught in turbulence and he has a clear line of vision, and similarly, the shorter rider can adjust the height to one that is shorter and appropriate for his head position and line of vision. Further, as alluded to above, a windshield of this embodiment can easily adjust from a relative tall height (depending on the rider) that protects the rider from wind, rain, cold, and road debris to a relative short height, which allows for air flow to the rider.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a front elevation view of a windshield in a low position, according to an embodiment of the invention.

FIG. 2 is an exploded perspective view of the windshield of FIG. 1.

FIG. 3 is an exploded perspective view of a windshield in a high position, according to an embodiment of the invention.

FIG. 4 is a front elevation view of a windshield according to the embodiment depicted in FIG. 3.

FIG. 5 is a front elevation view of a windshield in a high position, according to one embodiment of the invention.

FIG. 6 is an exploded perspective view of a windshield in a high position, according to one embodiment of the invention.

FIG. 7 is a top elevation view of a windshield, according to one embodiment of the invention.

FIG. 8 is a rear elevation view of a windshield in a high position, according to one embodiment of the invention.

FIG. 9 is a rear elevation view of a windshield in a middle position, according to one embodiment of the invention.

FIG. 10 is a rear elevation view of a windshield in a low position, according to one embodiment of the invention.

FIG. 11 is a perspective view of a windshield in a high position, according to another embodiment of the invention.

FIG. 12 is a top elevation view of the windshield of FIG. 11.

FIG. 13 is a front elevation view of the windshield of FIG. 11.

FIG. 14 is a rear elevation view of the windshield of FIG. 11.

FIG. 15 is a side elevation view of the windshield of FIG. 11.

FIG. 16 is a perspective view of a windshield in a low position, according to the embodiment of FIG. 11.

FIG. 17 is a side elevation view of the windshield of FIG. 16.

FIG. 18 is a front elevation view of the windshield of FIG. 16.

FIG. 19 is a rear elevation view of the windshield of FIG. 16.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

In the following detailed description of the various embodiments of the present invention, numerous specific details are set forth in order to provide a thorough understanding of various embodiments of the present invention. However, one skilled in the art will recognize that the present invention may be practiced without these specific details. In other instances, well-known methods, procedures, and components have not been described in detail so as to not unnecessarily obscure aspects of the various embodiments of the present invention. The drawings, which are not necessarily to scale, depict illustrative embodiments and are not intended to limit the scope of the invention.

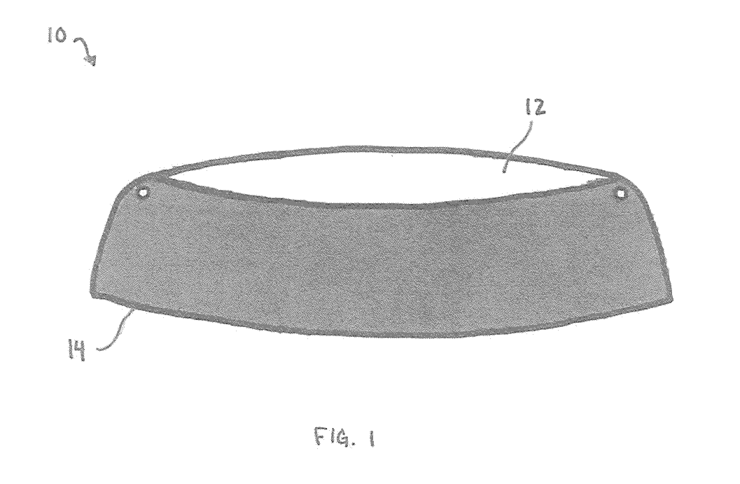

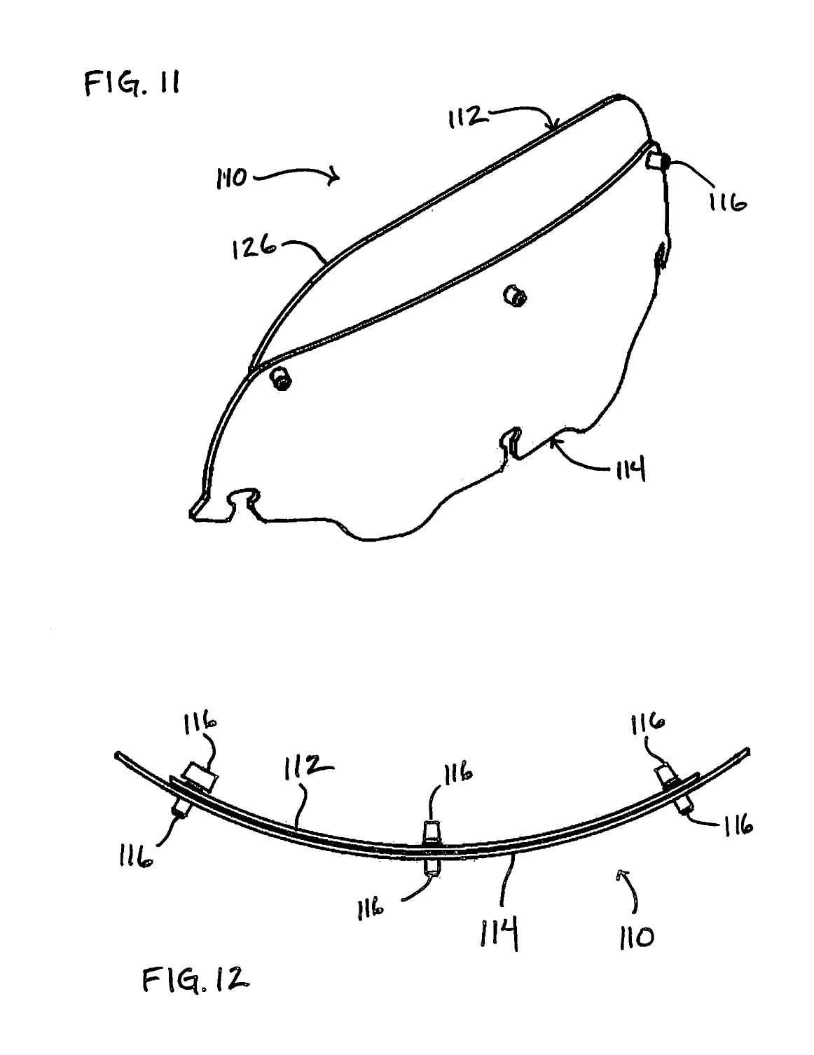

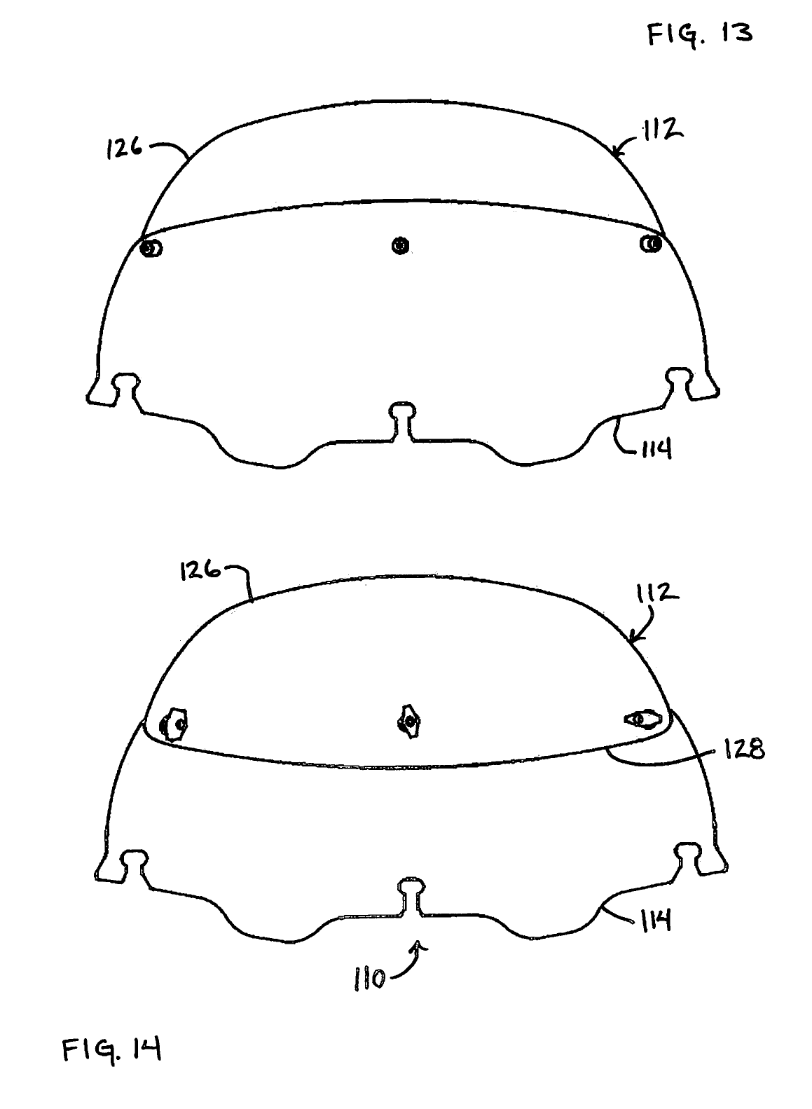

The adjustable motorcycle windscreen of the present invention provides a solution for motorcycle riders to quickly and easily adjust their windscreens to various heights. The invention can be more readily understood by reference to its application in FIGS. 1-19 and the following description. While the invention is not necessarily limited to such an application, the invention will be better appreciated using a discussion of exemplary embodiments in specific contexts. The terms “windscreen” and “windshield” are used interchangeably throughout this specification.

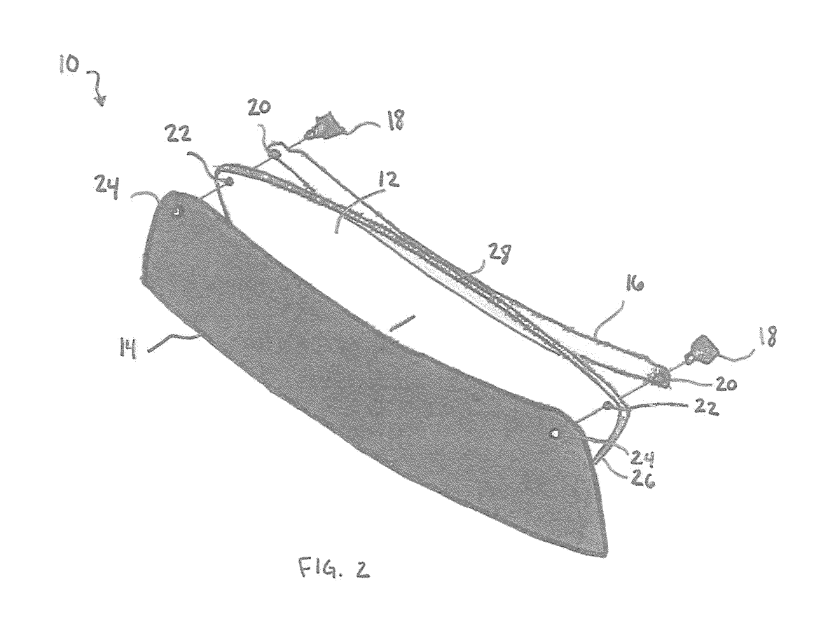

In one embodiment depicted in FIGS. 1-4, the invention comprises an adjustable windshield that is moveable between a fixed short (or lower) position and a fixed tall (or raised) position. Referring to FIG. 1, an adjustable motorcycle windshield 10 is depicted generally in its fixed short position. Windshield 10 has an adjustable upper portion 12 and a fixed lower portion 14. Lower (or base) portion 14 is configured to be mounted to the motorcycle. Referring to FIG. 2, the components of windshield 10 are better seen in this exploded view of FIG. 1. Upper portion 12 contains apertures 22 on each side of its face. Likewise, lower portion 14 contains nuts 24 on each side of its face in the same relative position as apertures 22. Nuts 24 may be embedded within, coupled via threaded ring, or otherwise implanted or affixed to lower portion 14. Horizontal crossbar 16 lies across upper portion 12. Crossbar 16 contains apertures 20 in the same relative position as apertures 22 and nuts 24. Fasteners 18 are placed on both sides of windshield 10 and can secure adjustable windshield 10 through crossbar aperture 20, upper portion aperture 22, and into lower portion nut 24.

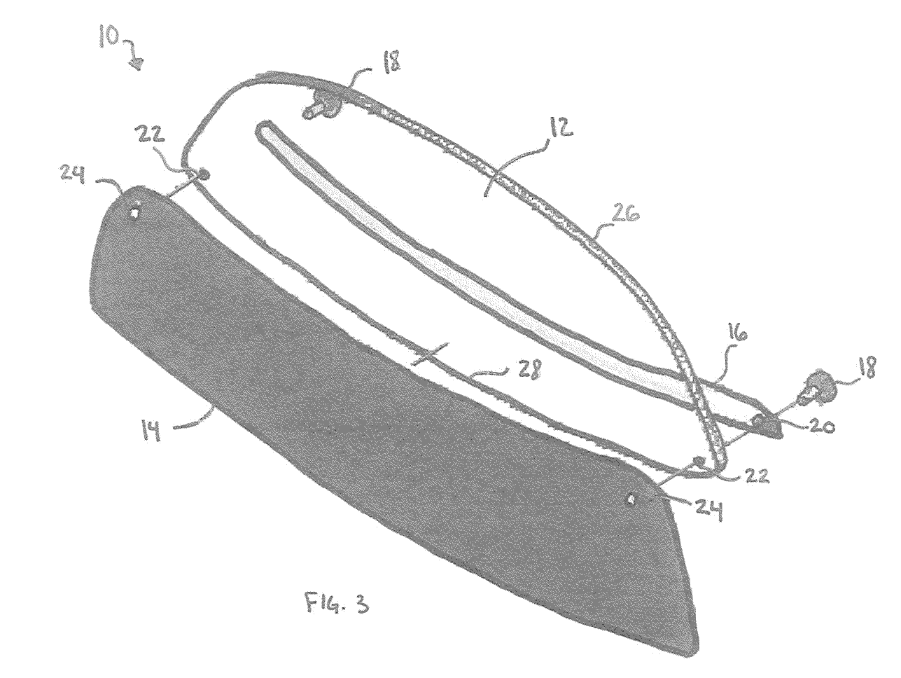

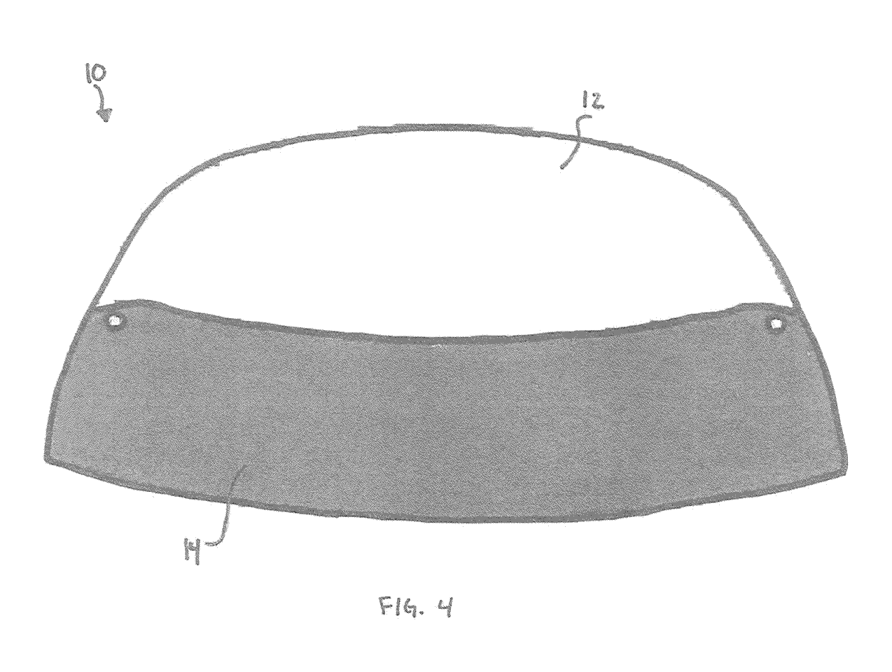

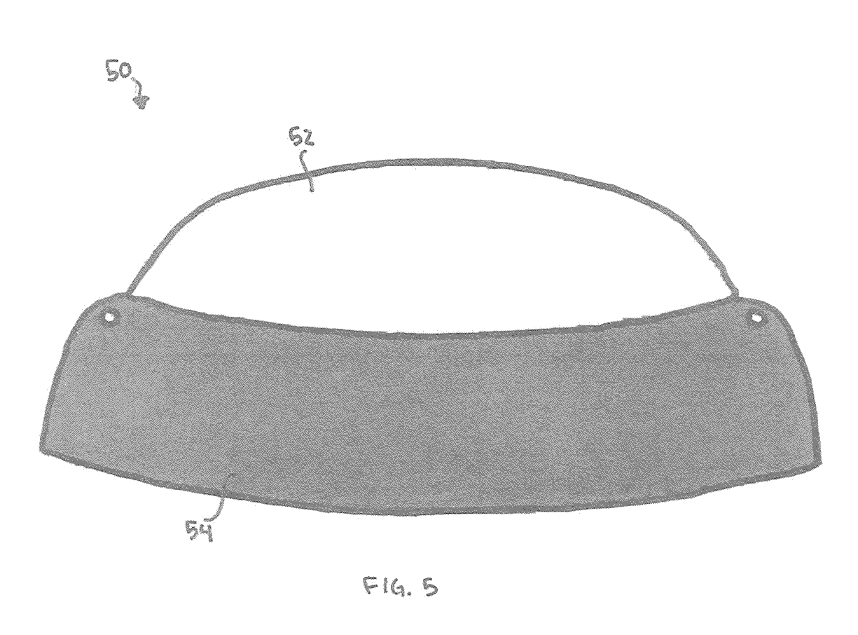

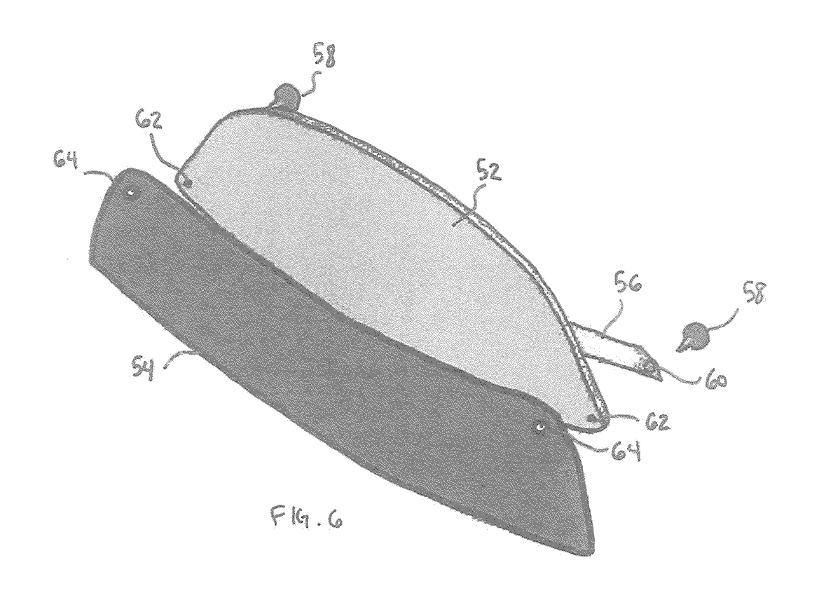

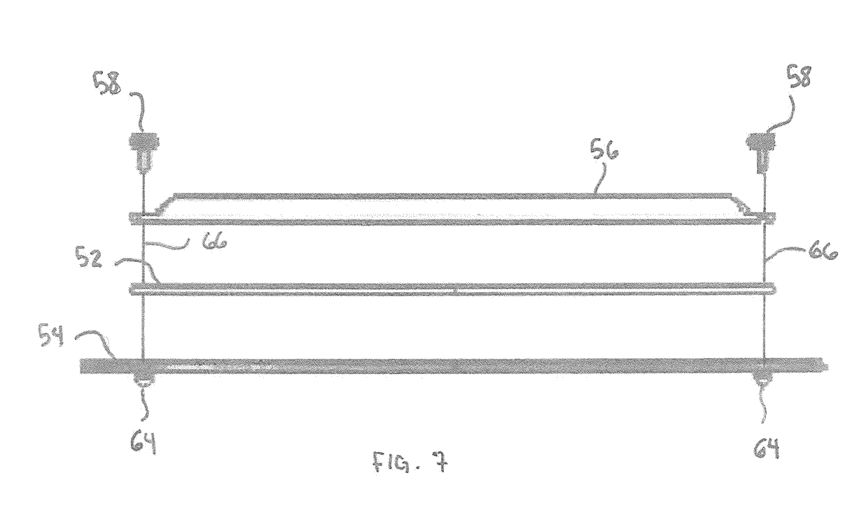

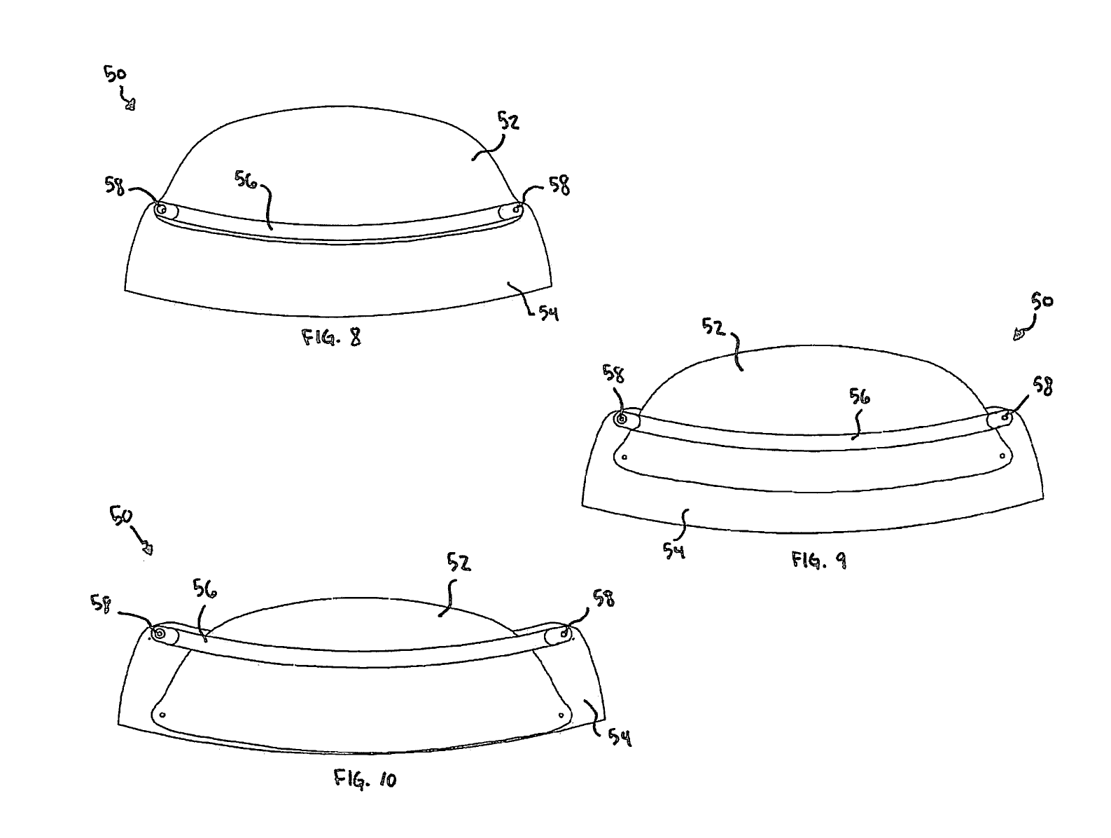

In operation, a comparison of FIGS. 2 and 3 and FIGS. 1 and 4 readily depict the adjustable nature of windshield 10. In FIG. 2, windshield 10 is in its fixed short position. In the fixed short position, upper portion 12 is positioned with side 26 facing down relative to the motorcycle and rider. Side 28 then faces up relative to the motorcycle and rider and provides for the shorter windshield. By comparison, FIG. 3 shows windshield 10 in its fixed tall position. In the fixed tall position, upper portion 12 is positioned with side 28 facing down relative to the motorcycle and rider. Side 26 then faces up and provides for the taller windshield. When adjusting from fixed short position depicted in FIGS. 1 and 2 to fixed tall position depicted in FIGS. 3 and 4, or vice versa, fasteners 18 are loosened from nuts 24. Upper portion 12 and crossbar 16 can then be removed from lower portion 14. Upper portion 12 can then be rotated 180 degrees about the axis perpendicular to the face of upper portion 12 and re-secured to lower windshield 14 by reinserting fasteners 18 through crossbar apertures 20, upper portion apertures 22, and into lower portion nuts 24.

In an optional embodiment not depicted, horizontal crossbar 16 is not needed for windshield 10. The tightening of fasteners 18 through apertures 20 and apertures 22 into nuts 24 adequately secures upper portion 12 to lower portion 14.

In another embodiment depicted in FIGS. 5-10, the height of the windshield may be set at a low position, a high position, or at any position therebetween. Referring to FIG. 5, windshield 50 is generally depicted as comprising an upper portion 52 and a lower portion 54. Lower portion 54 is mounted to the motorcycle. Referring now to FIGS. 6 and 7, upper portion 52 contains apertures 62 on opposite sides of its face. Likewise, lower portion 54 contains nuts 64 in the same relative position as apertures 62. Windshield 50 further contains crossbar 56.

Crossbar 56 contains apertures 60 in the same relative position as apertures 62 and nuts 64. Fasteners 58 are placed on both sides of windshield 50 and can secure adjustable windshield 50 in a fixed tall height through crossbar aperture 60, upper portion aperture 62, and into lower portion nut 64 along line 66. Further, lower portion 54 can be secured at any other height by securing crossbar 56 to lower portion 54 via fasteners 58 along line 66. Tightening fasteners 58 through apertures 60 of crossbar 56 and into nuts 64 of lower portion 54 creates force along the entire thee of crossbar 56 when it rests against upper portion 52. This force holds upper portion 52 securely in place.

hi operation upper portion 52 may be adjusted by loosening fasteners 58 from nuts 64. Once the pressure from crossbar 56 is adequately lessened, upper portion 52 is free to slide up or down. the rider can then position upper portion 52 at a desired position and retighten fasteners 58 through crossbar apertures 60 and into lower portion nuts 64, thus placing the requisite amount of force through crossbar 56 into upper portion 52 to hold it securely in place. Referring to FIGS. 8-10, windshield 50 is depicted as movable from a high position in FIG. 8, to a middle position in FIG. 9, and finally to a low position in FIG. 10, as viewed by the rider when seated. First, referring to FIG. 8. upper portion 52 of windshield 50 is positioned at its maximum height. Fasteners 58, as tightened through apertures 60 and into nuts 64 (not shown by the back view), provide the requisite force along crossbar 56 to secure upper portion 52 to lower portion 54. Windshield 50 is secured similarly when adjusted slightly downward from its maximum height, as depicted in FIG. 9. At this middle height, upper portion 52 is lowered downward along the face of lower portion 54 from its maximum height so that the exposed segment of upper portion 52 is lessened. Finally, referring to FIG. 10, upper portion 52 is lowered downward along the face of lower portion 54 so that the exposed segment of upper portion 52 is at its minimum. Upper portion 52 is secured as it was described when in its raised positions, by fasteners 58 tightening through apertures 60 and into nuts 64, thereby forcing crossbar 56 into upper portion 52 and ultimately against lower portion 54. Windshield 50 can therefore achieve a wide range of height adjustability.

By way of example only, in one embodiment windshield 50 can be up to twelve inches in total height in its tallest position, which is attained by combining the five inches of lower portion 54 and the seven inches of upper portion 52, when upper portion 52 is positioned at its maximum height. In its shortest position, windshield 50 can be as short as seven inches in total height, which is attained by combining the five inches of lower portion 54 with the two inches of lower portion 54 when lower portion 54 is positioned at its minimum height. Thus, the overall height of windshield 50 is adjustable within a range from seven inches to twelve inches. These dimensions are merely for purposes of illustration and should not be considered limiting.

Referring now to FIGS. 11-19, another embodiment of the invention is depicted. Windscreen 110 generally includes an upper portion 112, a base portion 114, and fastening means 116. Upper portion 112 includes a side 126 and a side 128, and various apertures or other features suitable for facilitating fastening to base portion 114 via fastening means 116. Base portion 114 includes various apertures or other features suitable for fastening base portion 114 to a motorcycle or other desired vehicle. Base portion 114 further includes various apertures or other features suitable for facilitating fastening to upper portion 112 via fastening means 116.

Fastening means 116 may comprise any suitable releasable or recloseable fastener, such as conventional nuts and bolts, bolts with well-nuts, 3M dual-lock fasteners, Dzus or other similar quarter-turn fasteners, and the like. One portion of fastening means 116 may include a winged head, as depicted in FIG. 14, for example. One of upper portion 112 or base portion 114 may include one or more threaded apertures to accept a fastener.

Upper portion 112 is selectively moveable between a lower fixed position, and a raised fixed position, wherein the overall height of the windscreen is greater in the raised position than in the lower position. In the embodiment of FIGS. 11-19, the side 126 is oriented upwards relative to the vehicle when upper portion 112 is in the raised position, while the side 128 is oriented upwards relative to the vehicle when upper portion 112 is in the lower position. Moving upper portion 112 between the raised and lower positions is therefore accomplished by rotating the upper portion one hundred eighty degrees from the orientation in FIG. 14 to the orientation in FIG. 19.

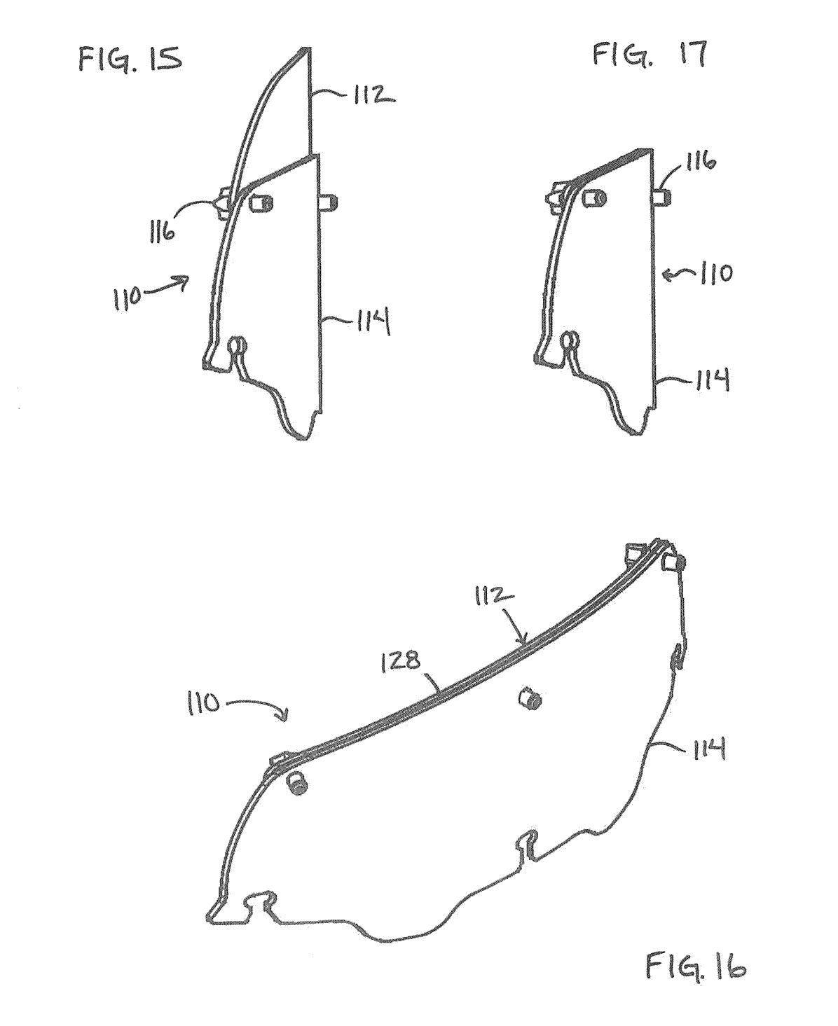

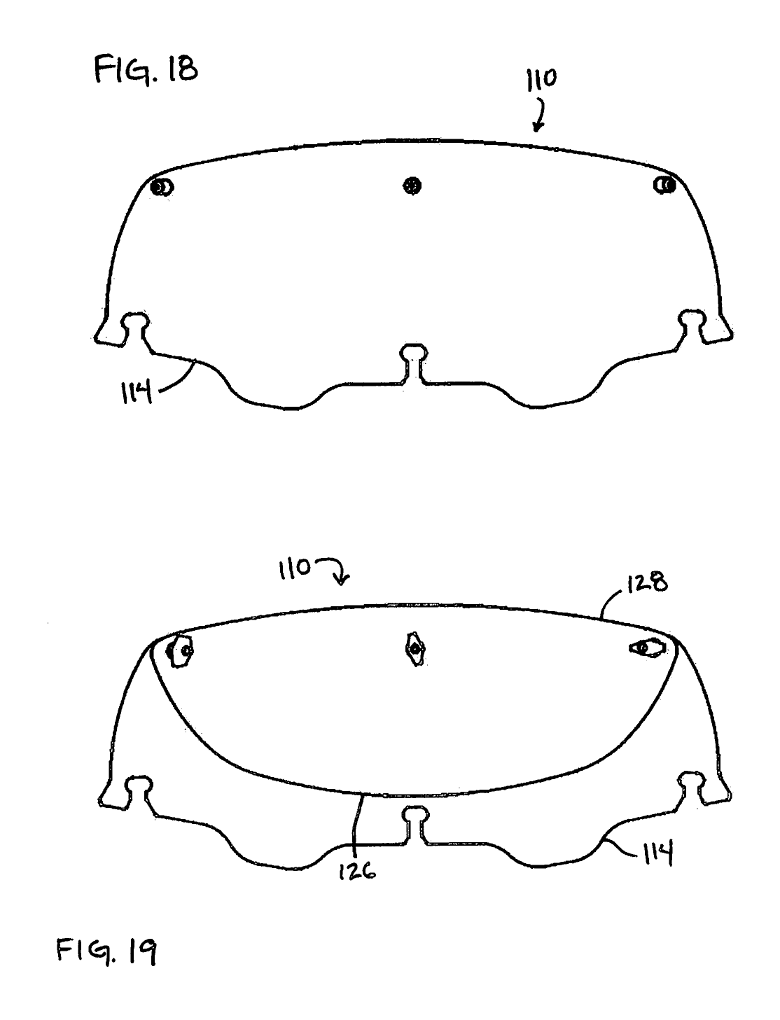

As can be seen in FIGS. 16-19, the profile and area of upper portion 112 is smaller than that of the profile and area of base portion 114, such that upper portion 112 is tucked behind base portion 114 when in the lower position. As in FIG. 18, upper portion 112 is not visible behind base portion 114 when viewed from the front, with side 128 of upper portion 112 being generally flush with a top edge of base portion 114.

In all embodiments described herein, suitable materials for the construction of the base and upper portions of the windscreen include polycarbonate, glycol-modified polyethylene terephthalate, acrylic polymers such as polymethyl methacrylate, and any other suitable materials known to one of ordinary skill in the art. The upper and base portions may be transparent, tinted, or opaque as desired or necessary to comply with appropriate regulations, although the upper portion will generally be constructed from a transparent material if the intended application is highway use.

While mainly described herein in the context of use with a motorcycle, the adjustable windshield of the present invention may also be suitable for other uses and applications, including for example: all-terrain vehicles, trikes or three-wheeled motorcycles, snowmobiles, personal watercraft, and other outdoor or recreational vehicles.

Various modifications to the embodiments of the inventions may be apparent to one of skill in the art upon reading this disclosure. For example, persons of ordinary skill in the relevant art will recognize that the various features described for the different embodiments of the inventions can be suitably combined, un-combined, and re-combined with other features, alone, or in different combinations, within the spirit of the invention. Likewise, the various features described above should all be regarded as example embodiments, rather than limitations to the scope or spirit of the inventions. Therefore, the above is not contemplated to limit the scope of the present inventions.

Persons of ordinary skill in the relevant arts will recognize that the inventions may comprise fewer features than illustrated in any individual embodiment described above. The embodiments described herein are not meant to be an exhaustive presentation of the ways in which the various features of the inventions may be combined. Accordingly, the embodiments are not mutually exclusive combinations of features; rather, the inventions may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the embodiments of the present inventions, it is expressly intended that the provisions of Section 112, sixth paragraph of 35 U.S.C. are not to be invoked unless the specific terms “means for” or “step for” are recited in a claim.

1. A height-adjustable windscreen for a vehicle, comprising:
a base portion configured to be attachable to the vehicle;
an upper portion configured to be selectively coupled to the base portion and moveable between a lower position and a raised position; and
a fastening means for selectively coupling the upper portion to the base portion.

2. The height-adjustable windscreen of claim 1, wherein the base portion is tinted.

3. The height-adjustable windscreen of claim 1, wherein the base portion defines a first profile and wherein the upper portion defines a second profile, the second profile having a smaller area than the first profile.

4. The height-adjustable windscreen of claim 1, wherein the upper portion includes a first edge and a second edge, the upper portion being configured such that the first edge comprises a top edge when the upper portion is in the lower position, and further configured such that the second edge comprises a top edge when the upper portion is in a raised position.

5. The height-adjustable windscreen of claim 1, wherein the upper portion may be coupled to the base portion at any position between the lower position and the raised position.

6. The height-adjustable windscreen of claim 1, wherein the upper portion includes a top edge and the base portion includes a top edge, wherein the top edge of the upper portion extends above the top edge of the base portion when the upper portion is in the lower position.

7. The height-adjustable windscreen of claim 1, wherein the upper portion includes a top edge and the base portion includes a top edge, and wherein the top edge of the upper portion is generally level with the top edge of the base portion when the upper portion is in the lower position.

8. The height-adjustable windscreen of claim 1, wherein the upper portion includes a top edge and the base portion includes a top edge, and wherein the top edge of the base portion extends above the top edge of the upper portion when the upper portion is in the lower position.
